(19) United States
(12) Patent Application Publication
(10) Pub. No.: US 2005/0073832 A1
(43) Pub. Date: Apr. 7, 2005

(54) Container having stabilizer

(75) Inventors: Albert Shilton, Pacific Palisades, CA (US); Ravi K. Sawhney, Calabasas, CA (US); William P. Debley, Northridge, CA (US); Lance G. Hussey, Simi Valley, CA (US); Craig R. Steele, Manhattan Beach, CA (US)

Correspondence Address: FOLEY & LARDNER, 2029 CENTURY PARK EAST, SUITE 3500, LOS ANGELES, CA, 90067, US

(73) Assignee: Shilton Investments Inc. and RKS Design

(21) Appl. No.: 10/678,198

(22) Filed: Oct. 2, 2003

(51) Int. Cl. F21V 33/00

(52) U.S. Cl. 362/101

(57) ABSTRACT

A container having a stabilizer. The container may include an inner housing for holding a substance and an outer sleeve having a taper, the outer sleeve being movably affixed to and surrounding a portion of the inner housing. The inner housing may have a hollow interior and may have an open end and a closed end. The closed end of the inner housing may be substantially flat. The outer sleeve may be movable about a length of the inner housing. The container may also include extendible and retractable “feet.” The taper may be sized to contact an automobile cup holder. Additionally, the taper may be curved. The container may also include a mechanism for maintaining a position of the outer sleeve with respect to the inner housing. The mechanism may be a ratchet.

### BACKGROUND

1. Field of the Invention

Embodiments of the present invention relate to containers and, in particular, to beverage containers having a taper, the position of which on the container is adjustable.

2. Description of Related Art

The fast pace of contemporary society has caused many people to alter what was once a normal schedule and combine several routine daily activities at once. Whether trying to meet a deadline at work for the latest proposal or trying to juggle the schedule of several school-aged children, or possibly trying to do both, the amount of time in a person's typical day available for activities that were once commonplace and taken for granted continues to shrink. For example, many people today do not take the time to sit at a table to eat meals. Rather, many people choose to eat and drink while driving in their cars. While not being the most relaxing way to consume a meal, eating and drinking “on the road” has become a common time saving activity, especially for commuters who are forced to sit in rush hour traffic on a daily basis. Even for those who skip meals such as breakfast, for example, it is still commonplace for commuters to at least carry a cup of coffee or other beverage on the way in to the office and have their morning coffee on the road while driving to work.

The automotive industry has responded to the proliferation of commuters who eat and drink while driving with convenience features in automobiles that facilitate the combining of multiple activities. For example, most cars and trucks manufactured today include cup holders as a fixed part of an automobile center console. The automotive industry, realizing that many people eat and drink in their cars, has included cup holders in their automobiles in response to the common need for drivers and their passengers to be able to place their drinks without worry that a slight bump in the road or a relatively sharp turn or quick stop will cause their drinks to fall over and spill.

In addition, the modern age of excess has forced the automotive industry to take a typical cup holder one step further. Many fast food restaurants, probably the primary source of food and drink being present in an automobile, allow patrons to “super size” their meals, i.e., for an additional fee, portions of the meal, such as french fries and soft drinks, will be increased to a large or extra large size. Likewise, many coffee houses today allow patrons to order “grande” size coffee drinks.

However, the “super size” and “grande” size beverage containers, while popular with many consumers, are typically too big to fit into a standard automobile cup holder. Because of the popularity of the larger size containers, the automotive industry has responded by including in their vehicles cup holders that would accommodate the larger containers. The larger cup holders are now standard features in many automobiles, especially in full size sport utility vehicles.

The larger cup holders, however, have proven to be disadvantageous for “regular” size beverage containers. For example, for those morning commuters who purchase a regular size cup of coffee for their morning commutes, the diameter of the larger cup holders can be so large that a regular size coffee cup will not fit securely within the confines of the cup holder. There is typically enough space between the largest part of a regular sized coffee cup and the walls of a larger cup holder that a sharp turn, quick stop or large bump could cause the coffee cup to fall over and spill, resulting in a coffee-stained vehicle at best and, given the typically extremely hot temperature of the coffee, severe burns at worst. Moreover, the problem is not limited to just morning coffee drinkers. Containers for a typical soft drink from a fast food restaurant are plagued with the same stability problem. The large cup holders are simply too large for a regular sized drink.

Some automobile manufacturers have compromised and equipped their automobiles with one regular sized cup holder and one larger sized cup holder. However, this solution is often inadequate in that if two people are traveling in the car, one is forced to use the regular sized cup holder and one is forced to use the larger sized cup holder. Thus, if a stable place to put one's drink is desired, as it often is, the size of the drinks ordered by the travelers is dictated not by the desires of the travelers themselves, but by the size of the cup holders available to them, a very unsatisfactory position.

### SUMMARY

It is therefore an object of the present invention to provide a container for various substances, such as beverages, for example, that is stable in automobile cup holders of varying sizes. It is a further object of embodiments of the present invention to provide a container that has a stabilizer, such as a moveable taper, at least one extendable member or “feet” that may be extended or retracted, or both a taper and at least one extendible member.

According to an embodiment of the present invention, a container may include an inner housing for holding a substance, the inner housing having a hollow interior and having an open end and a closed end, the closed end of the inner housing being substantially flat; and an outer sleeve having a stabilizer, the outer sleeve being movably affixed to and surrounding a portion of the inner housing. The outer sleeve may be movable about a length of the inner housing. The stabilizer may be a taper or at least one extendible member.

The outer surface of the inner housing may be substantially a right circular cylinder. Also, the inner housing and the outer sleeve may be concentric. The taper of the outer sleeve may narrow toward the closed end of the inner housing. The taper may be sized to contact an automobile cup holder. Additionally, the taper may be curved.

The container may further include a mechanism for maintaining a position of the outer sleeve with respect to the inner housing. The mechanism may be a ratchet. The container may further include at least one extendable member movably affixed to the outer sleeve. The at least one extendable member may extend away from the inner housing as the outer sleeve moves toward a closed end of the inner housing and may retract toward the inner housing as the outer sleeve moves toward the open end of the inner housing. The container may further include a lid removably affixable to the inner housing.

According to an embodiment of the present invention, a beverage container may include an inner housing for holding the beverage and an outer sleeve disposed about the inner housing. The outer sleeve may have a taper. The inner housing may have an open end and a closed end. The outer sleeve may be movable about an outer surface of the inner housing.

The taper of the outer sleeve may widen toward the open end of the inner housing. The taper may be sized to come into contact with an automobile cup holder. The taper may be curved.

The beverage container may further include a mechanism for maintaining a position of the outer sleeve along a length of the inner housing. The mechanism may be a ratchet.

The beverage container may further include feet affixed to the outer sleeve. The feet may extend away from the inner housing as the outer sleeve moves toward a closed end of the inner housing, and may retract toward the inner housing as the outer sleeve moves toward the open end of the inner housing. The beverage container may further include a lid removably affixable to the inner housing.

According to an embodiment of the present invention, a method for securing a container in an automobile cup holder may include positioning the container in the cup holder, the container having an inner housing and an outer sleeve, the inner housing having a hollow interior and having an open end and a closed end, the closed end being substantially flat, the outer sleeve having a taper, wherein the outer sleeve is movably affixed to and surrounds a portion of the inner housing, and wherein the outer sleeve is movable about a length of the inner housing; and may include adjusting the position of the outer sleeve with respect to the inner housing such that the taper of the outer sleeve makes contact with the cup holder. The taper of the outer sleeve may narrow toward the closed end of the inner housing. Also, the taper may be sized to contact the cup holder. The taper may be curved.

According to an embodiment of the present invention, a method for making a container may include providing an inner housing for holding a substance, the inner housing having a hollow interior and having an open end and a closed end, the closed end of the inner housing being substantially flat; and include positioning an outer sleeve about an exterior surface of the inner housing, the outer sleeve having a taper. The outer sleeve may be movably affixed about a length of the inner housing. The taper of the outer sleeve narrows toward the closed end of the inner housing. The taper may be sized to contact an automobile cup holder. Also, the taper may be curved.

### BRIEF DESCRIPTION OF THE DRAWINGS

FIG. 1 shows a perspective view of a container having a stabilizer with extendable members extended according to an embodiment of the present invention.

FIG. 2 shows a perspective view of a container having a stabilizer with extendable members retracted according to an embodiment of the present invention.

FIG. 3 shows an exploded view of a container having a stabilizer according to an embodiment of the present invention.

FIG. 4 shows a side view of a container having a stabilizer with extendable members retracted according to an embodiment of the present invention.

FIG. 5 shows another side view of a container having a stabilizer with extendable members retracted according to an embodiment of the present invention.

FIG. 6 shows a side view of a container having a stabilizer with extendable members partially extended according to an embodiment of the present invention.

FIG. 7 shows a side view of a container having a stabilizer with extendable members fully extended according to an embodiment of the present invention.

FIG. 8 shows an exploded view of a container having a stabilizer according to an embodiment of the present invention.

### DETAILED DESCRIPTION

In the following description of preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the preferred embodiments of the present invention.

Although the following description is directed primarily toward containers having moveable tapers and used for holding substances such as, but not limited to, beverages, for example, embodiments of the present invention may be implemented in a variety of ways and may be used in a variety of capacities and applications. For example, embodiments of the present invention may be used for stabilizing a container in an automobile cup holder. Generally, embodiments of the present invention may be adapted for use in any environment where a container must be stabilized to its surroundings.

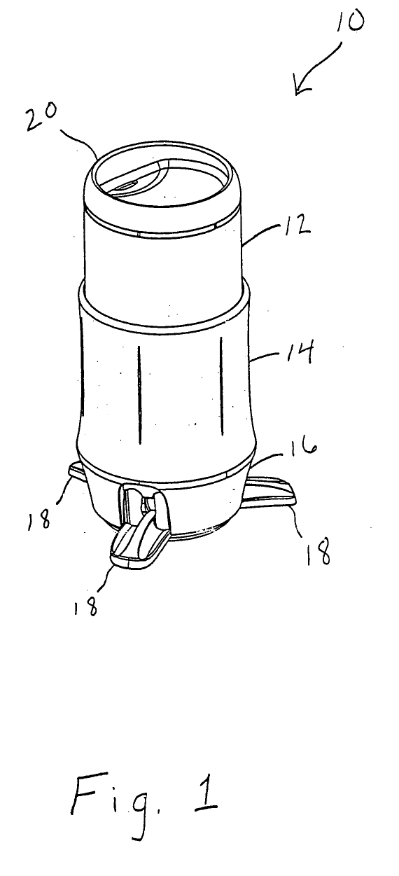

FIG. 1 shows a perspective view of a container having a stabilizer 10 according to an embodiment of the present invention. The container having a stabilizer 10 shown in FIG. 1 includes, but is not limited to, an inner housing 12, an outer sleeve 14, at least one extendable member 18 and a lid 20. In addition, the outer sleeve 14 includes, but is not limited to, an outer sleeve taper 16.

In the embodiment of the invention shown in FIG. 1, there are three extendable members 18. However, embodiments of the present invention are not limited to three extendable members and may include one or more extendable members. In the embodiment shown in FIG. 1, the extendable members are extended in a position substantially perpendicular to the inner housing 12. In this position, the extendable members 18 help stabilize the container having a stabilizer 10 when it is positioned on a table or other flat surface. Also, the extendable members 18 are extended away from the inner housing 12 while the outer sleeve 14 is positioned at one end of the inner housing 12 as will be explained in greater detail below.

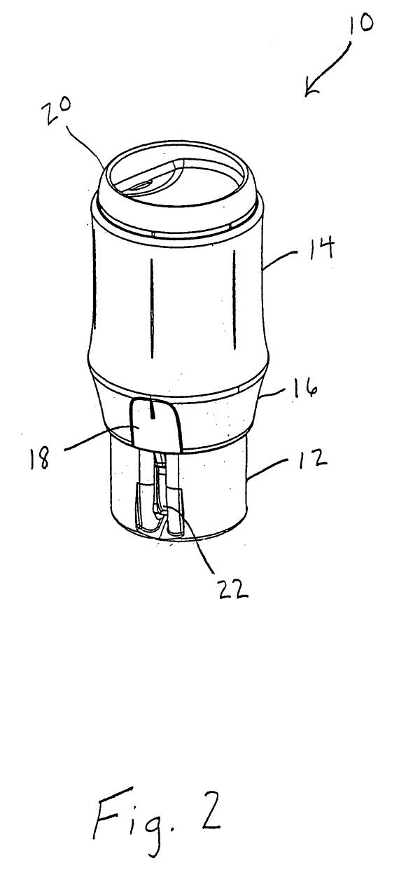

FIG. 2 also shows a perspective view of a container having a stabilizer 10 according to an embodiment of the present invention with an at least one extendable member 18 in a retracted position. As shown, the at least one extendable member 18 is in a retracted position when the outer sleeve 14 is positioned at another end of the inner housing 12. Also shown in FIG. 2 according to an embodiment of the present invention is a groove 22 used to effect the position of the at least one extendable member 18 as will be explained in greater detail below.

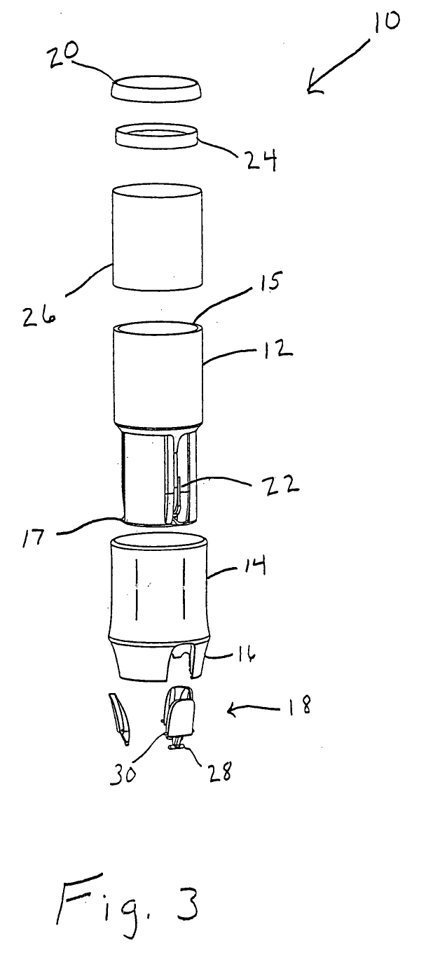

FIG. 3 shows an exploded view of the container having a stabilizer 10 according to an embodiment of the present invention. In FIG. 3, the container having a stabilizer 10 may include, but is not limited to, an inner housing 12, an outer sleeve 14, at least one extendable member 18 and a lid 20. The outer sleeve 14 may include, but is not limited to, an outer sleeve taper 16. In addition, includes, but is not limited to, a guide pin 28 and securing pins 30.

The inner housing 12 may be fabricated in a variety of ways. According to an embodiment of the present invention, the inner housing 12 as shown in FIG. 3 is substantially formed as a right circular cylinder having a hollow interior. Moreover, the inner housing 12 may include an open end 15 and a closed end 17. The closed end 17 may be substantially flat. The inner housing 12 may be fabricated out of a variety of materials including, but not limited to, plastic, aluminum, stainless steel and the like. According to embodiments of the present invention, the inner housing 12 may be fabricated out of materials that are suitable for hot or cold beverages.

The inner housing 12 may also be fabricated for thermal properties. For example, the inner housing 12 may be fabricated such that cold or hot beverages are thermally insulated. According to an embodiment of the present invention, the inner housing 12 may be fabricated with one or more hollow walls, for example. According to another embodiment of the present invention, if the inner housing 12 is fabricated with hollow walls, an interior portion of the hollow walls may be filled with an insulating material, such as, for example, air, styrofoam, fiberglass, or other insulating material, that facilitates maintenance of the temperature of the beverage within the interior portion of the inner housing 12.

According to an embodiment of the present invention, an outer portion of the inner housing 12 may be used for logos, trademarks, phrases and the like. For example, for marketing purpose, a corporation may include a company logo or phrase on an outer surface portion of the inner housing 12. Logos and the like may also be placed on other parts of the container having a stabilizer, such as, for example, the outer sleeve 14, the at least one extendable member 18, the lid 20 and the like.

Also, the inner housing 12 may be illuminated, such as with a light emitting diode (LED), for example. The LED may illuminate intermittently. According to an embodiment of the present invention, the LED may be disposed in an interior portion of the inner housing 12 and may be powered by a portable power source, such as a battery or a solar cell, for example.

According to an embodiment of the present invention, the inner housing 12 may also include a groove 22 for effecting the position of the at least one extendable member 18. The at least one extendable member 18 may include, but is not limited to, a guide pin 28 and a securing pin 30. In the embodiment of the invention shown in FIG. 3, there are three extendable members formed as “feet.” The securing pin 30 may be affixed to the outer sleeve 14 in such a way that it allows the extendable member 18 to rotate.

In addition, the guide pin 28 may be positioned within the groove 22 such that when the outer sleeve 14 is moved about a length of the inner housing 12 the movement of the guide pin within the groove 22 causes the extendable member to extend out away from the inner housing 12 as the outer sleeve 14 is moved toward the closed end 17 of the inner housing and to retract toward the inner housing 12 as the outer sleeve 14 is moved toward the open end 15 of the inner housing. However, embodiments of the present invention are not limited to the particular motion just described. Embodiments of the present invention may be implemented in any way that causes the at least one extendable member 18 to move away from or to move closer to the inner housing 12.

Although the embodiment of the invention shown in FIG. 3 includes a groove 22 and a guide pin 28 for effecting the movement of the at least one extendable member 18, embodiments of the invention are not limited to the particular scheme shown. Other embodiments of the invention may include various schemes for effecting the movement of the at least one extendable member 18. For example, levers, hinges, knobs, pulleys and the like may be implemented to effect the movement of the at least one extendable member 18.

For example, according to an embodiment of the present invention, the at least one extendable member 18 may be actuated with a twist mechanism or by depressing a button or other mechanism. According to an embodiment of the present invention, the at least one extendable member 18 may be loaded against springs and released by activation of a depressible button, a slide mechanism, a twist mechanism or other actuation mechanism. The springs may be disposed on or adjacent the inner housing 12, on or adjacent the outer sleeve 14 or on or adjacent some other portion of the container having a stabilizer 10. The actuation mechanism may be disposed in a variety of places. For example, the actuation mechanism may be disposed on or adjacent the lid 20, on or adjacent the inner housing 12, on or adjacent the outer sleeve 14 or on or adjacent some other portion of the container having a stabilizer 10.

According to an embodiment of the present invention, the outer sleeve 14 may be fabricated so that it surrounds at least a portion of the inner housing 12. According to the embodiment of the invention shown in FIG. 3, the outer sleeve 14 is concentric with the inner housing 12. In addition, the outer sleeve 14 may be fabricated out of a variety of materials including, but not limited to, plastic, aluminum, stainless steel and the like.

Moreover, the embodiment of the invention shown in FIG. 3 may include an outer sleeve taper 16. The outer sleeve taper 16 may be formed such that it narrows toward the closed end 17 of the inner housing 12 and so that it widens toward the open end 15 of the inner housing 12. In addition, the outer sleeve taper 16 may be curved. According to an embodiment of the present invention, the outer sleeve taper 16 may be sized such that it can make contact with an automobile cup holder as will be explained in greater detail below.

According to embodiments of the present invention, the outer sleeve 14 may include no taper at all. For example, the walls of the outer sleeve 14 may be substantially vertical with respect to a surface on which the container having a stabilizer 10 is placed. Moreover, a bottom portion of the outer sleeve 14 may be substantially flat such that, when positioned at the closed end 17 of the inner housing 12, the distance between the inner housing 12 and an automobile cup holder, for example, is minimized or eliminated.

The length of the outer sleeve 14 may be varied. For example, the length of the outer sleeve 14 may extend along a substantial portion of the inner housing 12 or may extend along only a small portion of the inner housing 12. For example, the length of the outer sleeve 14 may be sized such that it is adequate for causing the at least one extendible member 18 to extend or retract or such that it is adequate for minimizing or eliminating a distance between the inner housing 12 and an automobile cup holder. Moreover, the outer sleeve 14 may include, but is not limited to, ribs or other element extending away from the outer sleeve 14 that may contact an automobile cup holder. Thus, for embodiments of the present invention that do not include an outer sleeve taper 16, the ribs or other element extending away from the outer sleeve 14 may provide a similar function.

According to embodiments of the present invention, the outer sleeve 14 may be fabricated to facilitate gripping of the container having a stabilizer 10. For example, a surface of the outer sleeve 14 may be fabricated in a friction-increasing manner, such as, for example, with a relatively rough surface or a raised pattern, that increases a user's ability to hold on to the outer sleeve 14.

The outer sleeve 14 may also be fabricated for thermal properties. For example, the outer sleeve 14 may be fabricated such that cold or hot beverages are thermally insulated. According to an embodiment of the present invention, the outer sleeve 14 may be fabricated with one or more hollow walls, for example. According to another embodiment of the present invention, if the outer sleeve 14 is fabricated with hollow walls, an interior portion of the hollow walls may be filled with an insulating material, such as, for example, air, styrofoam, fiberglass, or other insulating material, that facilitates maintenance of the temperature of the beverage within the interior portion of the inner housing 12.

According to an embodiment of the present invention, an outer portion of the outer sleeve 14 may be used for logos, trademarks, phrases and the like. For example, for marketing purposes, a corporation may include a company logo or phrase on an outer portion of the inner housing 12. Moreover, the outer sleeve 14 may be used in conjunction with the inner sleeve 12 to provide “conceal and reveal” advertising. For example, according to embodiments of the present invention, when the outer sleeve 14 is positioned at the open end 15 of the inner housing 12, the outer sleeve 14 may conceal any logo, slogan, trademark or other marking on the inner housing 12. When the outer sleeve 14 is positioned toward the closed end 17 of the inner housing 12, any logo, slogan, trademark or other marking on the inner housing 12 may be revealed. Thus, for example, if the inner housing 12 were imprinted with the word “GO” and if the outer sleeve 14 were imprinted with “USA” and positioned toward the open end 15 of the inner housing 12, someone viewing the container having a stabilizer 10 would see only “USA.” However, according to an embodiment of the present invention, if the outer sleeve 14 were moved and positioned at the closed end 17 of the inner housing 12, a viewer would see the phrase “GO USA.”

Also, the outer sleeve 14 may be illuminated, such as with an LED, for example. The LED may illuminate intermittently. According to an embodiment of the present invention, the LED may be disposed in an interior portion of the outer sleeve 14 and may be powered by a portable power source, such as a battery, for example.

According to the embodiment of the invention shown in FIG. 3, the container having a stabilizer 10 may also include, but is not limited to, a ring 24 and an inner housing sleeve 26. The inner housing sleeve 26 may be positioned so that it conforms to an interior surface of the inner housing 12. The inner housing sleeve 26 may be fabricated to provide additional insulation for the inner housing 12, thus making it suitable for providing additional temperature maintenance for hot or cold beverages. In addition, the inner housing sleeve 26 may provide an anchoring point for the lid 20 and the ring 24.

The ring 24 may be affixed to the lid 20 in such a way that it comes into contact with the inner housing sleeve 26 or some other anchoring point within the inner housing 12. The lid 20 itself may be fabricated such that it has an opening suitable for allowing a user to drink a beverage that exists within the interior of the inner housing 12. The lid 20 may be secured to the open end 15 of the inner housing 12 in a variety of ways that are commonly known in the art.

Also, the lid 20 may be illuminated, such as with an LED, for example. The LED may illuminate intermittently. According to an embodiment of the present invention, the LED may be disposed in an interior portion of the lid 20 and may be powered by a portable power source, such as a battery, for example.

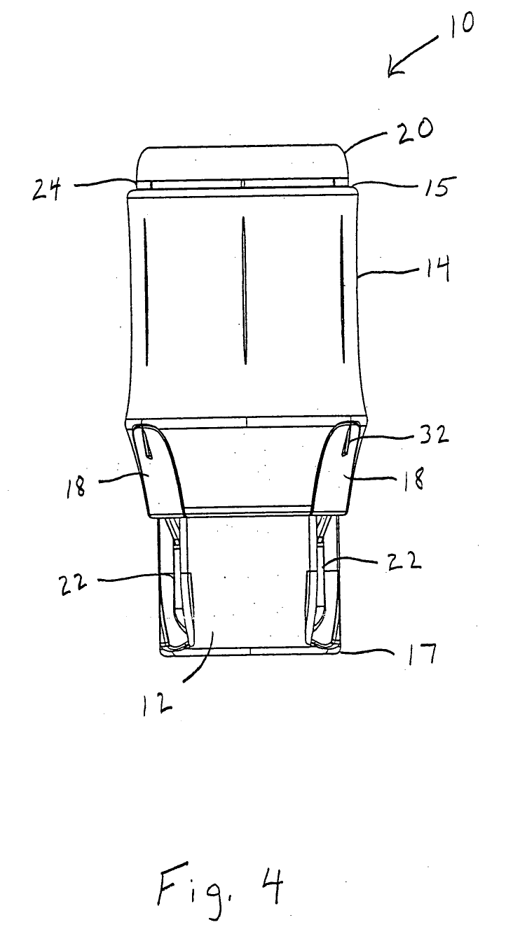

Operation of the container having a stabilizer 10 may be seen with reference to FIGS. 4-7. In FIG. 4, the outer sleeve 14 is positioned toward the open end 15 of the inner housing 12. In this position, the at least one extendable member 18 is retracted toward the inner housing 12 so that it is flush with the outer sleeve 14. The outer sleeve 14 may be maintained in the position shown in FIG. 4 by a variety of methods. For example, the outer sleeve 14 may be maintained in its position along the length of the inner housing 12 simply by friction fit. According to another embodiment of the present invention, a mechanism, such as a ratchet, for example, may be used to maintain the position of the outer sleeve 14 along the length of the inner housing 12. The ratchet may be disposed on or adjacent the inner housing 12, on or adjacent the outer sleeve 14, or on or adjacent another portion of the container having a stabilizer 10 and function between the inner housing 12 and the outer sleeve 14 such that the position of the outer sleeve 14 relative to the inner housing is maintained unless moved by a user.

Other mechanisms to maintain the position of the outer housing 14 with respect to the inner sleeve 12 may also be employed. For example, according to an embodiment of the present invention, the mechanism may include a “bayonet” type thread running along a portion of an outer surface of the inner housing 12 that interfaces with the outer sleeve 14 or vice versa. According to another embodiment of the present invention, the outer sleeve 14 may employ a track or friction mechanism running along a portion of an outer surface of the inner housing 12 that interfaces with the outer sleeve 14, or vice versa, which releases the outer sleeve 14 when it is twisted. According to yet another embodiment of the present invention, the mechanism may include a ring, such as a tapered nylon ring, for example, running along a portion of an outer surface of the inner housing 12 that interfaces with the outer sleeve 14, or vice versa, such that the outer sleeve 14 may rotate a number of degrees to engage the ring, similar to the mechanism used to lock the legs of a camera tripod at different heights. According to yet another embodiment of the present invention, the outer sleeve 14 may be spring loaded and may require a slight twist before moving it along the inner housing 12. Other mechanisms well-known in the art may also be employed to maintain the position of the outer sleeve 14 with respect to the inner housing 12.

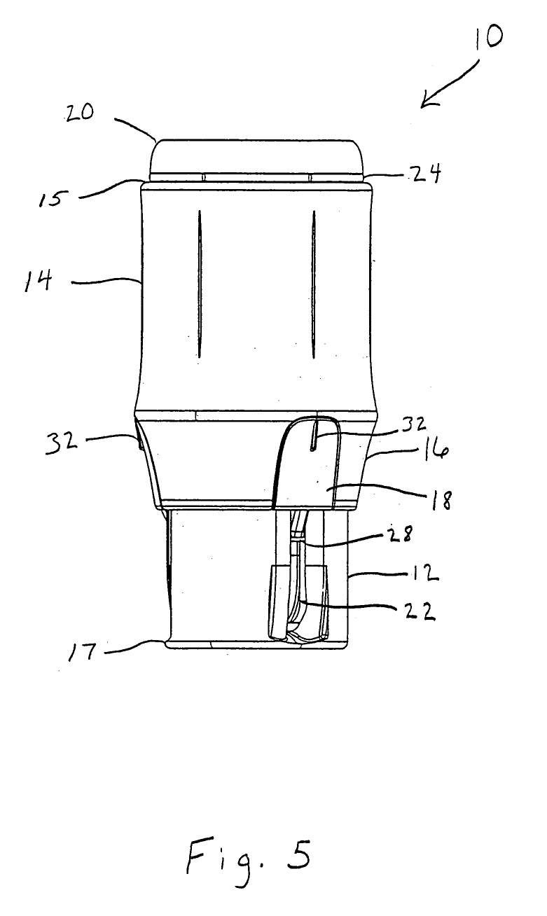

FIG. 5 shows another view of the embodiment of the invention shown in FIG. 4. In the view shown in FIG. 5, the outer sleeve taper 16 is more visible than in the view shown in FIG. 4. During use, the container having a stabilizer 10 may be positioned in an automobile cup holder. Depending on the size of the cup holder, the outer sleeve taper 16 may come into contact with the cup holder when the container having a stabilizer 10 is positioned in the cup holder. The outer sleeve taper 16 may be sized such that it may contact the various sizes of cup holders commonly found in automobiles. In addition, according to the embodiment of the invention shown in FIG. 5, the outer sleeve taper 16 is curved, facilitating contact between the outer sleeve taper 16 and an automobile cup holder. The curve of the outer sleeve taper 16 may be formed specifically to provide maximum contact or stability with common automobile cup holders.

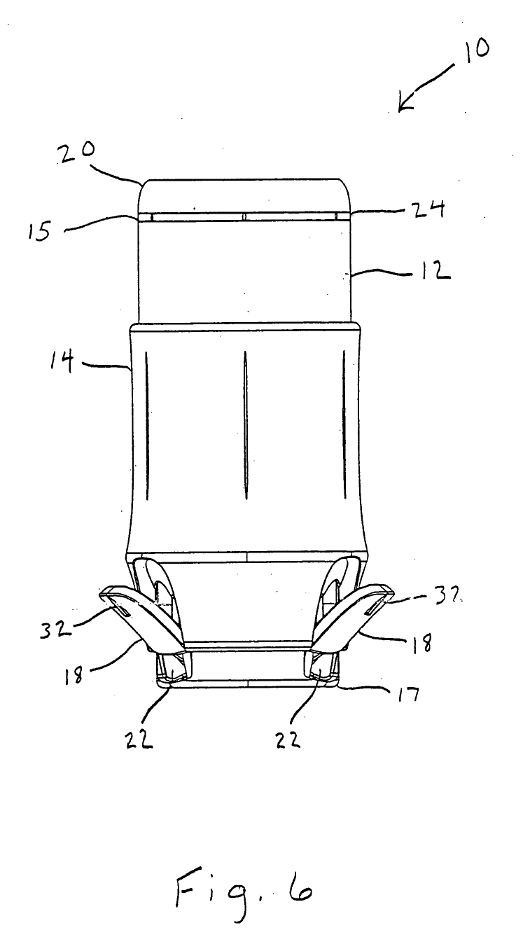

If the container having a stabilizer 10 is positioned in an automobile cup holder while the outer sleeve 14 is positioned at the open end 15 of the inner housing 12 and the outer sleeve taper 16 does not make contact with the automobile cup holder, the outer sleeve 14 may be moved toward the closed end 17 of the inner housing 12 so that the outer sleeve taper 16 comes into contact with the automobile cup holder, thereby stabilizing the container having a stabilizer 10 within the cup holder. If the automobile cup holder is so large that the outer sleeve taper 16 cannot make contact with it, as is sometimes the case with current automobile cup holders that are sized to hold extremely large beverage containers, the outer sleeve 14 may be moved further toward the closed end 17 of the inner housing 12 so that, as the guide pins 28 on the extendable members 18 move through the groove 22, the extendable members 18 begin to extend away from the inner housing 12. According to an embodiment of the present invention, a container having a stabilizer 10 having extendable members 18 partially extended may be seen in FIG. 6. As the extendable members 18 extend away from the inner housing 12, they may come into contact with the automobile cup holder, thereby securing and stabilizing the container having a stabilizer 10 within the cup holder.

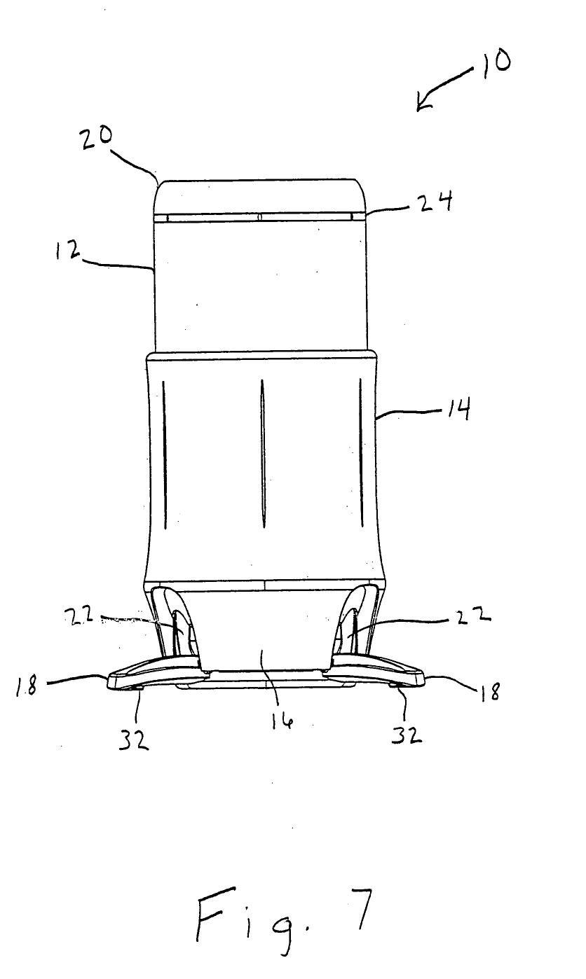

FIG. 7 shows a side view of a container having a stabilizer 10 according to an embodiment of the present invention with the extendable members 18 fully extended away from the inner housing 12. In the embodiment of the invention shown in FIG. 7, the extendable members 18 are substantially perpendicular to the inner housing 12 and may allow a user to position the container having a stabilizer 10 on a table or other flat surface without worry that the container having a stabilizer 10 will fall or tip over. In addition, the extendable members 18 may include, but are not limited to, one or more stabilizers 32 that may aid in positioning and stabilizing the container having a stabilizer 10 on a table or other flat surface.

According to embodiments of the present invention, a variety of mechanisms may be used to extend the at least one extendible member 18. For example, the at least one extendible member 18 need not be associated with movement of the outer sleeve 14. Instead of the groove 22 and the guide pin 28 described above, according to an embodiment of the present invention, the at least one extendible member 18 may be extended or retracted using a button or other moveable mechanism, for example, located in or on a portion of the container having a stabilizer 10, such as in or on a handle, for example. For example, a button or other moveable mechanism may be disposed on the inner housing 12 or the outer sleeve 14 and may be connected via springs, links or other mechanisms to the at least one extendible member 18 such that when the button or other moveable mechanism is activated, the at least one extendible member 18 extends. According to another embodiment of the present invention, the at least one extendible member 18 may be extended or retracted by manually pulling out, using one's fingers, the at least one extendible member 18.

According to another embodiment of the present invention, other mechanisms may also be employed to extend or retract the at least one extendible member 18. For example, the at least one extendible member 18 may be extended or retracted by twisting a moveable ring disposed at a bottom portion of the inner housing 12 or the outer sleeve 14 that may be connected via springs, links or other mechanisms to the at least one extendible member 18 such that when the a moveable ring is twisted, the at least one extendible member 18 extends.

Also, the at least one extendible member 18 may be illuminated, such as with an LED, for example. The LED may illuminate intermittently. According to an embodiment of the present invention, the LED may be disposed in an interior portion of the at least one extendible member 18 and may be powered by a portable power source, such as a battery, for example.

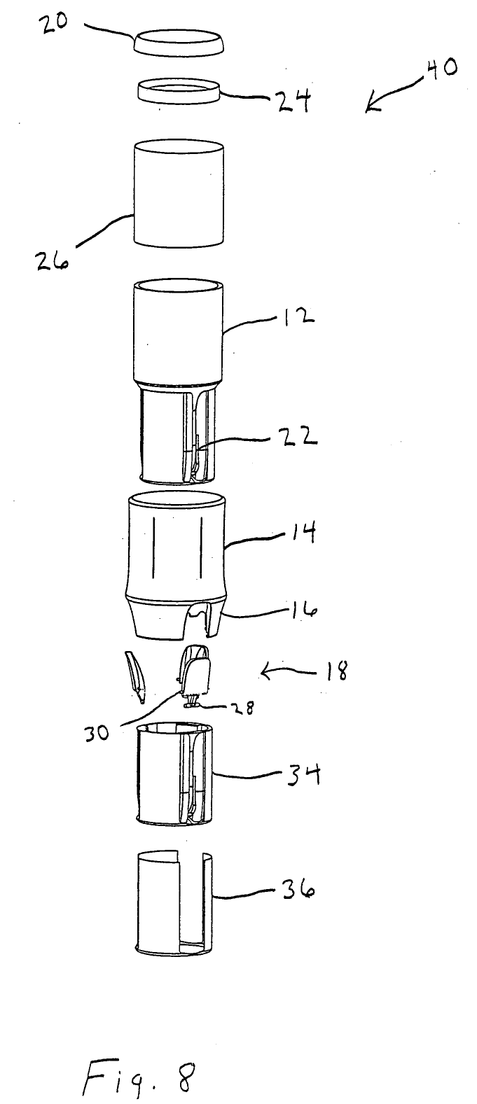

FIG. 8 shows an exploded view of a container having a stabilizer 40 according to an embodiment of the present invention. The embodiment of the invention shown in FIG. 8 includes, but is not limited to, all of the elements shown in FIG. 3. In addition, the embodiment of the invention shown in FIG. 8 includes, but is not limited to, a guide sleeve 34 and a guide cover 36. The guide sleeve 34 and the guide cover 36 may be positioned along the portion of the inner housing 12 having the groove 22. By utilizing the guide sleeve 34 and the guide cover 36, the container having a stabilizer 40 may be made in a variety of colors and using a variety of materials. The guide sleeve 34 and the guide cover 36 provide the fabricator of the container having a stabilizer 10 with various decorative and marketing possibilities. For example, the guide sleeve 34 and guide cover 36 may include a variety of colors, corporate logos, phrases and the like.

By using embodiments of the present invention, the varying size of automobile cup holders need not be of concern to persons having beverages in their cars. For example, for a morning commuter who drinks a cup of coffee while driving to work, coffee may be poured into a container having a stabilizer 10 according to embodiments of the present invention and placed into an automobile cup holder. Depending on the size of the automobile cup holder, the container having a stabilizer 10 may fit snugly into the automobile cup holder where it may rest in a stable position. However, if the automobile cup holder is substantially larger than the container having a stabilizer 10, according to an embodiment of the present invention, the outer sleeve 14 may be moved along the length of the inner housing 12 toward the closed end 17 of the inner housing 12 until the outer sleeve taper 16 comes into contact with a wall or other portion of the automobile cup holder. Once the outer sleeve taper 16 comes into contact with a wall or other portion of the automobile cup holder, the container having a stabilizer 10 will be stabilized and will be prevented from moving within the confines of the automobile cup holder.

If, however, the diameter or other dimension of the automobile cup holder is so larger that the outer sleeve taper 16 cannot come into contact with a wall of the automobile cup holder, as the outer sleeve 14 is moved toward the closed end 17 of the inner housing 12, the at least one extendable member 18 may extend away from the inner housing 12 so that it comes into contact with a wall or other portion of the automobile cup holder, thereby stabilizing the container having a stabilizer 10 and preventing the container having a stabilizer 10 from moving within the confines of the automobile cup holder.

Moreover, embodiments of the present invention need not include the outer sleeve 14. According to an embodiment of the present invention, the at least one extendible member 18 may be moveably affixed to the inner housing 12 and may be extended or retracted using one of the methods described above or using another method well-known in the art. Embodiments of the invention having an inner housing 12 and at least one extendible member 18 but not having an outer sleeve 14 are advantageous in that manufacturing costs may be reduced.

While particular embodiments of the present invention have been shown and described, it will be obvious to those skilled in the art that the invention is not limited to the particular embodiments shown and described and that changes and modifications may be made without departing from the spirit and scope of the appended claims.

1. A container comprising:
an inner housing for holding a substance, the inner housing having an top end and a bottom end; and
an outer sleeve having a stabilizer, the outer sleeve being not removable from the inner housing,
wherein the outer sleeve is movable between a first position and a second position.

2. The container of claim 1, wherein the stabilizer is a taper.

3. The container of claim 1, wherein the stabilizer is at least one extendible member.

4. The container of claim 1, wherein an outer surface of the inner housing is substantially a circular cylinder.

5. The container of claim 1, wherein the inner housing and the outer sleeve are concentric.

6. The container of claim 2, wherein the taper of the outer sleeve narrows toward the closed end of the inner housing.

7. The container of claim 2, wherein the taper is sized around its periphery to an inner periphery of an automobile cup holder.

8. The container of claim 2, wherein the taper is curved.

9. The container of claim 1, wherein the outer sleeve is movably affixed to the inner housing via friction.

10. The container of claim 1, further comprising a mechanism for maintaining a position of the outer sleeve with respect to the inner housing.

11. The container of claim 10, wherein the mechanism is a ratchet.

12. The container of claim 10, wherein the mechanism includes a thread.

13. The container of claim 10, wherein the mechanism is spring loaded.

14. The container of claim 3, wherein the at least one extendable member is movably affixed to the outer sleeve.

15. The container of claim 14, wherein the at least one extendable member extends away from the inner housing as the outer sleeve moves toward the bottom end of the inner housing, and
wherein the at least one extendable member retracts toward the inner housing as the outer sleeve moves toward the top end of the inner housing.

16. The container of claim 3, further comprising a depressible member for extending the at least one extendible member.

17. The container of claim 3, further comprising a slidable mechanism for extending the at least one extendible member.

18. The container of claim 3, further comprising a rotatable mechanism for extending the at least one extendible member.

19. The container of claim 1, further comprising a lid removably affixable to the inner housing.

20. The container of claim 1, wherein the inner sleeve includes multiple spaced walls.

21. The container of claim 1, wherein the outer housing includes multiple spaced walls.

22. The container of claim 1, further comprising a light source for illuminating the outer sleeve.

23. The container of claim 1, further comprising a light source for illuminating the inner housing.

24. The container of claim 3, further comprising a light source for illuminating the at least one extendable member.

25. The container of claim 19, further comprising a light source for illuminating the lid.

26. The container of claim 2, further comprising at least one extendible member movably affixed to the outer sleeve.

27. The container of claim 3, wherein the outer sleeve includes a taper.

28. The container of claim 1, wherein the bottom end is substantially flat.

29. A method for securing a container in an automobile cup holder comprising:
positioning the container in the cup holder, the container having an inner housing and an outer sleeve, the inner housing having an interior and having a top and a bottom, the outer sleeve having a stabilizer, wherein the outer sleeve is movably affixed to and surrounds a portion of the inner housing, and wherein the outer sleeve is movable about a length of the inner housing; and
adjusting the position of the outer sleeve with respect to the inner housing such that the stabilizer makes contact with the cup holder.

30. The method of claim 29, wherein the stabilizer is a taper.

31. The method of claim 29, wherein the stabilizer is at least one extendible member adjacent the outer sleeve.

32. The method of claim 30, wherein the taper of the outer sleeve narrows toward the bottom of the inner housing.

33. The method of claim 30, wherein a periphery of the taper is sized to a periphery of the cup holder.

34. The method of claim 30, wherein the taper is curved.

35. The method of claim 31, wherein the at least one extendable member extends away from the inner housing as the outer sleeve moves toward the bottom of the inner housing, and
wherein the at least one extendable member retracts toward the inner housing as the outer sleeve moves toward the top of the inner housing.

36. A method for making a container comprising:
providing an inner housing for holding a substance, the inner housing having an interior and having a top and a bottom; and
positioning an outer sleeve about an exterior surface of the inner housing, the outer sleeve having a stabilizer,
wherein the outer sleeve is not removable from the inner housing, and
wherein the outer sleeve is movable between a first position and a second position.

37. The method of claim 36, wherein the stabilizer is a taper.

38. The method of claim 36, wherein the stabilizer is at least one extendible member.

39. The method of claim 37, wherein the taper of the outer sleeve narrows toward the closed end of the inner housing.

40. The method of claim 37, wherein a periphery of the taper is sized to a periphery of an automobile cup holder.

41. The method of claim 37, wherein the taper is curved.

42. The method of claim 36, further comprising at least one extendible member disposed adjacent the inner housing.

43. A container comprising:
an inner housing for holding a substance, the inner housing having an interior and having a bottom;
at least one extendable member disposed adjacent to the inner housing, the at least one extendable member being not removable from the inner housing wherein the at least one extendable member is extendable away from the inner housing.

44. The container of claim 43, further comprising a mechanism for extending the at least one extendible member away from the inner housing and retracting the at least one extendible member toward the inner housing, the mechanism being disposed adjacent the inner housing.

45. The container of claim 43, wherein the bottom of the inner housing is substantially flat.

46. A container for an automobile cup holder comprising:
means for positioning the container in the cup holder, the container having an inner housing and an outer sleeve, the inner housing having an interior, the outer sleeve having a stabilizer, wherein the outer sleeve is movably affixed to and surrounds a portion of the inner housing, and wherein the outer sleeve is movable from a first position to a second position; and
means for adjusting the position of the outer sleeve with respect to the inner housing such that the stabilizer of the outer sleeve makes contact with the cup holder.

47. The container of claim 46, wherein the stabilizer is a taper.

48. The container of claim 46, wherein the stabilizer is at least one extendible member.
